(19) United States
(12) Patent Application Publication
(10) Pub. No.: US 2004/0064336 A1
(43) Pub. Date: Apr. 1, 2004

(54) Carrier vehicle running management assisting system and communication terminal device

(75) Inventors: Haruji Muramatsu, Shizuoka (JP); Haruyuki Miyazaki, Shizuoka (JP); Hiroki Oishi, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 10/658,414

(22) Filed: Sep. 10, 2003

(30) Foreign Application Priority Data
Sep. 27, 2002 (JP) 2002-284095

(51) Int. Cl. G06F 17/60

(52) U.S. Cl. 705/1

(57) ABSTRACT

The loadage of liquefied gas loaded on a tank lorry vehicle 1 measured on the basis of the load detected by a load sensor 16a attached to at a predetermined position of the tank lorry vehicle 1. The loadage as well as the position information obtained from a GPS signal, time information and vehicle specifying information is transmitted to a business place trough a portable telephone packet communication network 2 and a dedicated line 3. The business place receives the position information, time information, vehicle specifying information and loadage, and produces these items of information as outputs. The tank lorry vehicle 1 collects running information of one's own vehicle whose recording is legally compelled and records it in correlation with the loadage on a memory card 14. The business place 4 reads the running information and loadage from the memory card 14, and issues a report correlated with the running information and loadage. In this configuration, the business place exactly knows the behavior of the carrier vehicle such as a tank lorry vehicle, thereby performing effective vehicle running management.

### BACKGROUND OF THE INVENTION

1. Field of the Invention

This invention relates to a system for assisting the running management of a carrier vehicle for carrying predetermined material goods to a predetermined destination, and a communication terminal device used therefor. More particularly, this invention relates to a system for assisting the running management of a tank lorry which carries e.g. liquefied gas to a predetermined user.

2. Description of the Related Art

For example, the tank lorry vehicle which carries e.g. the liquefied gas fills an in-vehicle tank with a high pressure liquefied gas at a liquefied gas producing base, and moves while sequentially supplying the liquefied gas to a plurality of users' factories. In this case, in order to calculate the fee corresponding to the weight of the liquefied gas discharged at respective places, the weight of the discharged liquefied gas must be known. For this purpose, generally, the procedure of “platform transaction” has been adopted.

In the platform transaction, before and after the liquefied gas is discharged at a predetermined user's factory, the tank lorry vehicle carrying the liquefied gas measures the weight of the entire vehicle placed on a truck scale at a “base platform” or “in-city platform” equipped with the truck scale, and acquires the weight of the liquefied gas discharged at the factory from the difference between the vehicle weights before and after the liquefied gas is discharged. On the basis of the weight difference, a bill is submitted later.

However, the platform transaction is problematic from the viewpoint of a measuring cost, transporting cost, transporting time, etc. Therefore, as described in JP-A-2002-148108, a load cell is provided between a body frame and tank to measure the quantity of the liquefied gas directly. Otherwise, in place of the platform transaction, there has been proposed a “level gauge transaction” in which the level gauge attached to the tank for supplying the liquefied gas measures the quantity of transaction, and a method of measuring the discharged quantity by a flowmeter mounted in the tank lorry.

However, the above method of using the load cell presents the problems of a complicated structure, difficulty of attachment, etc. The above method of using the level gauge, as the case may be, produces an error in the discharged quantity because the user may use the liquefied gas while the liquefied gas is being supplied. Further, the method of using the flowmeter presents a problem of temperature management to maintain accuracy of measurement.

On the other hand, it is known that the liquefied gas suffers from gas-loss due to transportation because of the property of being vaporized. These methods can shorten the transporting distance and time to a certain degree. However, the management of the moving behavior of the tank lorry vehicle inclusive of a loadage has not been performed so that more effective management of the running of the tank lorry is demanded. Further, more effective management of the running of the tank lorry by knowing the need on the user's side in a real time is demanded.

### SUMMARY OF THE INVENTION

In view of the circumstance described above, an object of this invention is to provide a carrier vehicle running management assisting system in which a business place side can exactly know the behavior of a carrier vehicle such as a tank lorry to perform the running management thereof effectively, and a communication terminal device employed therein.

In order to attain the above object, in accordance with the first aspect, as seen from FIG. 1 showing the basic configuration of this invention, there is provided a system for assisting running management of a plurality of carrier vehicles which carry predetermined material goods to a predetermined destination,

position information acquiring means (1a) mounted on the carrier vehicle, for acquiring one's own vehicle position information on the basis of a GPS signal;

time information acquiring means (1b) mounted on the carrier vehicle, for acquiring time information corresponding to the position information;

vehicle specifying information storing means (1c) mounted on the carrier vehicle, for storing vehicle specifying information used to specify one's own vehicle;

vehicle specifying information acquiring means (1d) mounted on the carrier vehicle, for acquiring the vehicle specifying information from the vehicle specifying storing means;

loadage measuring means (1e) for measuring loadage of the material goods loaded on the carrier vehicle on the basis of load detected by a load sensor attached to a predetermined position of the carrier vehicle;

transmitting means (1f) mounted on the carrier vehicle, for transmitting the position information, time information, vehicle specifying information and loadage to a business place through a communication network inclusive of a wireless line;

receiving means (4a) installed on the business place to which the carrier vehicle belongs, for receiving the position information, time information, vehicle specifying information and loadage through the communication network; and

outputting means (4b) installed on the business place, for outputting the position information, time information, vehicle specifying information and loadage (claim 1).

According to this configuration, the loadage of material goods loaded on the carrier vehicle is measured on the basis of load detected by a load sensor attached to a predetermined position of the carrier vehicle. The loadage as well as the position information, time information, vehicle specifying information of one's own vehicle detected on the basis of the GPS signal is transmitted from the carrier vehicle to a business place through a communication network inclusive of a wireless line. The business place receives the position information, time information, vehicle specifying information and loadage and outputs these items of information. In this way, the business place can exactly know the behavior of the carrier vehicle inclusive of the loadage and the position information of the carrier vehicle.

In the assisting system, as seen from FIG. 1, preferably, the carrier vehicle is a tank lorry vehicle for carrying liquefied gas produced at a liquefied gas producing base to a predetermined user (claim 2). In this configuration, the business place can exactly know the behavior of the carrier vehicle inclusive of the loadage and the position information of the tank lorry vehicle. This make unnecessary the measurement at a platform, and unnecessary the reciprocating transportation to/from a predetermined platform.

As seen from FIG. 1, preferably, the above configuration of the system further comprises

delivery quantity computing means (1g) mounted on the tank lorry vehicle, for computing a delivery quantity of the liquefied gas to the user on the basis of the load, wherein the transmitting means and the receiving means transmits and receives the delivery quantity, respectively, and the outputting means outputs the delivery quantity (claim 3).

In this configuration, the delivery quantity of the liquefied gas to the user is computed on the basis of the load, and transmitted to the business place and displayed there. Therefore, the business place instantaneously know if or not a scheduled delivery has been done punctually.

As seen from FIG. 1, preferably, in the assisting system, the outputting means (4b) further outputs a loss quantity of the liquefied gas lost during carrying of the liquefied gas by the tank lorry vehicle (claim 4). According to this configuration, since the loss quantity of the liquefied gas lost during carrying of the liquefied gas is outputted, cost management can be exactly done.

As seen from FIG. 1, preferably, the assisting system further comprises:

delivery statement issuing means (1h) mounted on the tank lorry vehicle, for issuing a delivery statement for a user supplied with the liquefied gas on the basis of the delivery quantity (claim 5). According to this configuration, a face-to-face transaction can be performed.

As seen from FIG. 1, preferably, the assisting system further comprises:

running history information saving means (4c) installed on the business place, for saving, as running history information, the position information, time information, vehicle specifying information, loadage and delivery quantity, and

bill issuing means (4d) installed on the business place, for creating/issuing a bill for the user supplied with the liquefied gas on the basis of the running history information (claim 6).

According to this configuration, on the side of the business place, since the bill is issued on the basis of the running history information which has been transmitted from the tank lorry vehicle through the predetermined communication line and saved, the accuracy of the bill is improved and the work of issuing the bill can be greatly facilitated.

As seen from FIG. 1, preferably, the assisting system further comprises:

running history information saving means (4c) installed on the business place, for saving, as running history information, the position information, time information, vehicle specifying information, loadage and delivery quantity, and

report issuing means (4e) installed on the business place, for creating/issuing a bill for the user supplied with the liquefied gas on the basis of the running history information (claim 7).

According to this configuration, on the side of the business place, since the report is issued on the basis of the running history information which has been transmitted from the tank lorry vehicle through the predetermined communication line and saved, the work of issuing the report can be greatly facilitated.

As seen from FIG. 1, in the assisting system, preferably, the outputting means (4b) outputs the running history information superposed on a map image of a related district (claim 8).

According to this configuration, since the running history information superposed on a map image of a related district is outputted, visibility is improved and the running management of the tank lorry vehicle can be done exactly and effectively.

As seen from FIG. 1, preferably, the assisting system further comprises:

remaining level measuring means (6e) attached to a tank installed on the user's side, for measuring the remaining level of the liquefied gas in the tank;

remaining level warning information creating means (6f) attached to the tank, for creating remaining level warning information indicative of that the remaining level has become lower than a prescribed waning level;

tank position information acquiring means (6a) attached to the tank, for acquiring tank position information of one's own tank on the basis of the GPS signal;

warning time information acquiring means (6b) attached to the tank, for acquiring warning time information which is a time when the remaining level warning information is created;

tank specifying information storing means (6c) attached to the tank, for specifying tank specifying information used to specify one's own tank;

tank specifying information acquiring means (6d) attached to the tank, for acquiring the tank specifying information from the tank specifying information storing means; and

tank-side transmitting means (6g) attached to the tank, for transmitting the tank position information, warning time information, tank specifying information and remaining level warning information, wherein

the receiving means (4a) further receives the tank position information, warning time information, tank specifying information and remaining level information through the communication network, and

the outputting means (4b) further receives items of the tank position information, warning time information, tank specifying information and remaining level information through the communication network (claim 9).

According to this configuration, since the remaining level warning information of the liquefied gas in the tank of the user's side as well as the tank position information, warning time information, tank specifying information is transmitted through the communication network inclusive of a wireless line, the business place receives these items of information and output them. Therefore, the business place can carry out the running management more effectively in view of the real-time demand on the user's side.

As seen from FIG. 1, in the assisting system, preferably,

the items of information transmitted from the transmitting means and the tank-side transmitting means are saved in a server of an application service provider communicated with the transmitting means and the tank-side transmitting means through a portable telephone packet communication network in a data quantity accounting system as the wireless communication network; and

the receiving means (4a) installed on the business place receives the items of information saved in the server using an internet (claim 10).

According to this configuration, the assisting system employs the portable telephone packet communication network in a data quantity accounting system as the wireless communication network. The business place can acquire respective items of information from the server of the application service provider using the internet. Therefore, the effective assisting system can be easily constructed at low running cost.

In accordance with this invention, there is provided a communication terminal device installed on a carrier vehicle for providing a predetermined item of information on running of the carrier vehicle to a business place to which a plurality of carrier vehicles for carrying a predetermined material good to a predetermined destination belong, comprising

position information acquiring means (1a) for acquiring one's own position information on a GPS signal;

time information acquiring means (1b) for acquiring time information corresponding to the position information;

vehicle specifying information storing means (1c) for storing vehicle specifying information used to specify one's own vehicle;

vehicle specifying information acquiring means (1d) for acquiring the vehicle specifying information from the vehicle specifying information storing means;

loadage measuring means (1e) for measuring loadage of the material good carried on one's own vehicle on the basis of a load detected by a load sensor attached to a predetermined position of one's own vehicle;

transmitting means (1f) mounted on the carrier vehicle, for transmitting the position information, time information, warning time information, vehicle specifying information and loadage to the business place through a predetermined communication network including a wireless line (claim 11).

According to this configuration, the loadage of the liquefied gas loaded on the carrier vehicle is measured on the basis of load detected by a load sensor attached to a predetermined position of the carrier vehicle. The loadage as well as the position information, time information, vehicle specifying information of one's own vehicle detected on the basis of the GPS signal is transmitted from the carrier vehicle to a business place through a communication network inclusive of a wireless line. In this way, the business place can exactly know the behavior of the carrier vehicle inclusive of the loadage and the position information of the carrier vehicle.

In accordance with this invention, there is also provided a communication terminal device attached to a tank installed on a side of a predetermined user for providing predetermined information on the tank to a business place to which a tank lorry vehicle carries and supplies liquefied gas to the user belongs to, comprising:

tank position information acquiring means (6a) for acquiring tank position information of the user's own tank on the basis of a GPS signal in response to remaining level warning information indicative of shortage of the liquefied gas in the tank;

warning time information acquiring means (6b) for acquiring warning time information which is a time when the remaining level warning information;

tank specifying information storing means (6c) for storing tank specifying information which specifies the user's own tank;

tank specifying information acquiring means (6d) attached to the tank, for acquiring the tank specifying information from the tank specifying information storing means;

tank-side transmitting means (6g) for transmitting the tank position information, warning time information, tank specifying information and remaining level warning information to the business place through a predetermined communication network including a wireless line (claim 12).

According to this configuration, the remaining level warning information of the liquefied gas in the tank on the user's side as well as the tank position information, warning time information and tank specifying information is transmitted to the business place through a predetermined communication network including a wireless line. Therefore, the business place can provide timely supply of the liquefied gas in view of the real-time demand on the user's side.

In accordance with this invention, there is provided a a system for assisting running management of a plurality of carrier vehicles which carry predetermined material goods to a predetermined destination,

position information acquiring means (1a) mounted on the carrier vehicle, for acquiring one's own vehicle on the basis of a GPS signal;

time information acquiring means (1b) mounted on the carrier vehicle, for acquiring time information corresponding to the position information;

vehicle specifying information storing means (1c) mounted on the carrier vehicle, for storing vehicle specifying information used to specify one's own vehicle;

vehicle specifying information acquiring means (1d) mounted on the carrier vehicle, for acquiring the vehicle specifying information from the vehicle specifying storing means;

loadage measuring means (1e) for measuring loadage of the material goods loaded on the carrier vehicle on the basis of load detected by a load sensor attached to a predetermined position of the carrier vehicle;

transmitting means (1f) mounted on the carrier vehicle, for transmitting the position information, time information, vehicle specifying information and loadage to a business place through a communication network inclusive of a wireless line;

running information collecting/recording means (1i) mounted on the carrier vehicle, for collecting running information of one's own vehicle whose recording is at least legally compelled and for recording the running information in correlation with the loadage on a portable recording medium (1j);

receiving means (4a) installed on the business place to which the carrier vehicle belongs, for receiving the position information, time information, vehicle specifying information and loadage through the communication network;

outputting means (4b) installed on the business place, for outputting the position information, time information, vehicle specifying information and loadage;

running information reading means (4f) installed on the business place, for reading the running information and loadage from the portable recording medium; and

report issuing means (4e) for creating/issuing a report correlated with the running information and the loadage (claim 13).

According to this configuration, the loadage of material goods loaded on the carrier vehicle is measured on the basis of load detected by a load sensor attached to a predetermined position of the carrier vehicle. The loadage as well as the position information, time information, vehicle specifying information of one's own vehicle detected on the basis of the GPS signal is transmitted from the carrier vehicle to a business place through a communication network inclusive of a wireless line. The business place receives the position information, time information, vehicle specifying information and loadage and outputs these items of information. In this way, the business place can exactly know the behavior of the carrier vehicle inclusive of the loadage and the position information of the carrier vehicle. Further, the carrier vehicle collects running information of one's own vehicle whose recording is at least legally compelled and records the running information in correlation with the loadage on a portable recording medium. The business place reads the running information and loadage from the portable recording medium and issues are port correlated with the running information and the loadage. In this way, as required, the business place can provide, to the user, more exact running information inclusive of the speed, time and distance and loadage related thereto.

As seen from FIG. 1, in the assisting system, preferably, the running information collecting means is a tachograph, and

the portable recording medium is a memory card having a security function (claim 14).

According to this configuration, using the known device and card, the security of the running information and the loadage related thereto which are to be provided to the user can be protected.

The above and other objects and features of the invention will be more apparent from the following description taken in conjunction with the accompanying drawings.

### BRIEF DESCRIPTION OF THE DRAWINGS

FIG. 1 is a block diagram showing the basic arrangement of this invention;

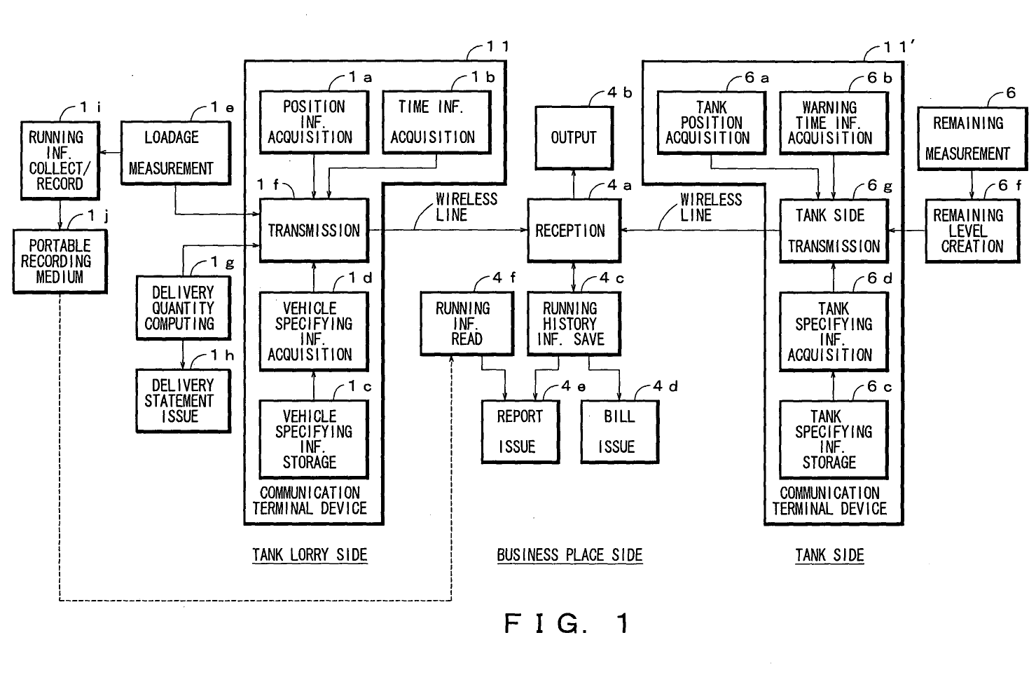

FIG. 2 is a view showing the system configuration according to an embodiment of this invention;

FIG. 3 is a block diagram showing the configuration of a communication terminal according to an embodiment of this invention and various devices;

FIG. 4 is a flowchart of the processing procedure at the tank lorry vehicle and the business place and the communication sequence therebetween according to an embodiment of this invention;

FIG. 5 is a flowchart of the processing procedure at the tank and business place and the communication sequence therebetween according to an embodiment of this invention;

FIG. 6 is a view of an example of history data according to an embodiment of this invention;

FIG. 7 is a view showing the map of the running status of a carrier vehicle;

FIG. 8 is a view showing the map of the history data; and

FIG. 9 is an exemplary report issued on the basis of card information.

### DESCRIPTION OF THE PREFERRED EMBODIMENTS

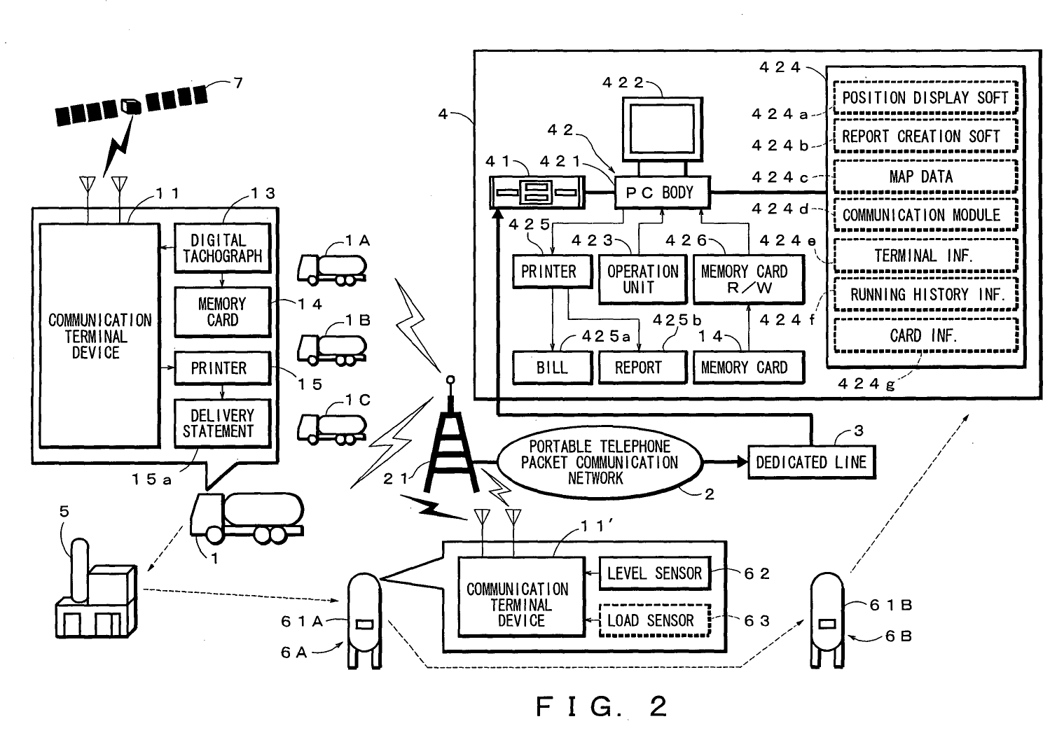

Now referring to the drawings, an explanation will be given of various embodiments of this invention. FIG. 2 is a view showing the system configuration according to an embodiment of this invention. In FIG. 2, a plurality of tank lorry vehicles 1 (inclusive of tank lorry vehicles 1A, 1B, 1C, etc.) transmit a delivery quantity of a liquefied gas by one's own vehicle to an assigned business place 4 through a portable telephone packet communication network 2 and dedicated line 3. The business place 4 receives the information transmitted from the tank lorry vehicle 1 and performs the running management of each tank lorry vehicle 1. Each tank lorry vehicle 1 receives a GPS signal that is a positioning radio wave transmitted from a plurality of GPS satellites which constitute a GPS (Global Positioning System), and acquires the position information of one's own vehicle which is a piece of running information. Incidentally, the tank lorry vehicle 1 corresponds to a carrier vehicle defined in claims of this application.

According to an instruction from the assigned business place 4, along a running path indicated by a dotted line with arrows, each tank lorry vehicle 1 fills an in-vehicle tank with a predetermined high-pressure liquefied gas at a liquefied gas producing base 5, and moves while supplying the liquefied gas to tanks 61A and 61B installed on users' factories 6A and 6B at a plurality of places. The tank lorry vehicle 1, as well known, is equipped with an in-vehicle tank for storing the liquefied gas to be transported. The structure of the tank lorry itself, which is well known, will not be further described in detail.

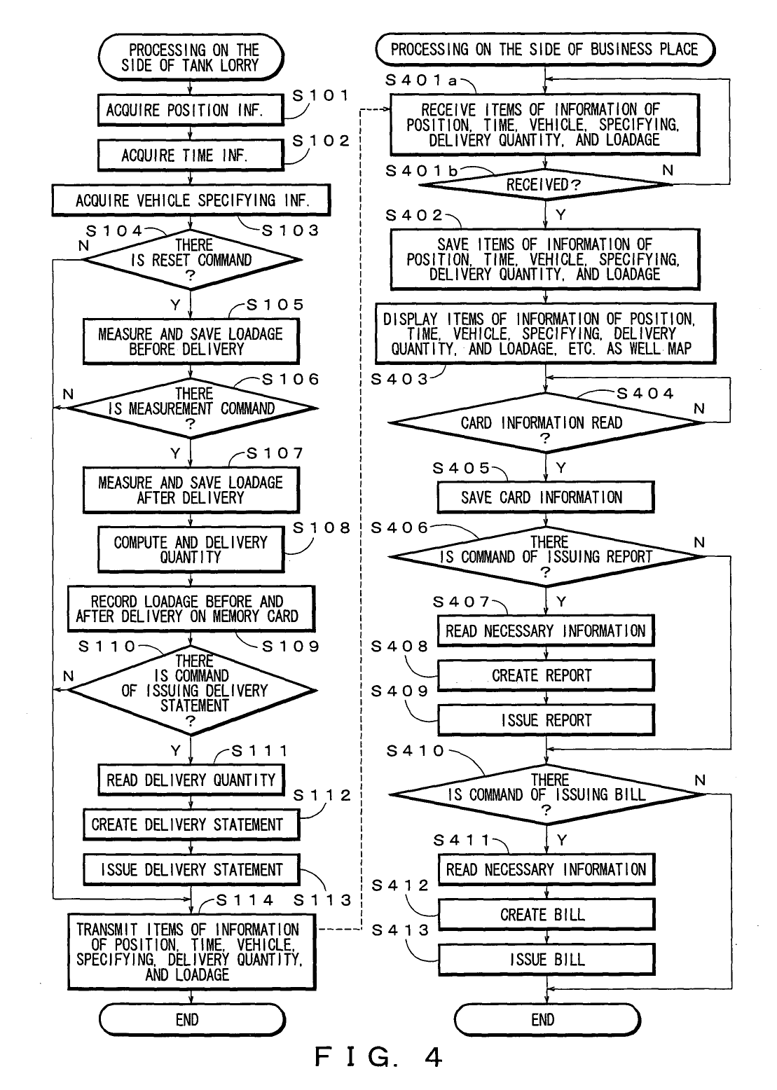

The tank lorry vehicle 1 includes a communication terminal device 11, a digital tachograph 13 for recording the running information of one's own vehicle whose recording on a memory card 14 is legally compelled, a printer 15 for printing an invoice 15a, etc. The communication terminal device 11 acquires position information and time information and transmits, to the business place 4, these items of information as well as vehicle specifying information for specifying the vehicle incorporating this device 11 and loadage and delivery quantity which are computed on the basis of the load detected by a load sensor. In response to an instruction of issuing an invoice by a predetermined operation of switching, the printer 15 prints out the invoice 15a on the basis of the detected load. These operations will be explained again with reference to FIG. 4. Incidentally, the load sensor may be a known distortion sensor. The load sensor is attached to e.g. the frame or axle of the tank lorry 1 to produce a load value based on the distortion. This example, which is described in JP-A-2002-71437, will not be explained further in detail. The digital tachograph 13 and memory card 14 correspond to the running information collecting/recording means and portable recording medium, and may be well known products.

The portable telephone packet communication network 2 may be e.g. “DoPa” served by NTT DOCOMO Corporation. This service is a data communication service using a packet conversion in a portable telephone network. This service adopts a data quantity accounting system in which the fee of communication is accounted according to the quantity of communicated data. This system contributes to employ the system according to this invention at low rates. The portable telephone packet communication network 2 can be communicated with the communication terminal devices 11, 11′ through a wireless base station 21. The portable telephone packet communication network 2 is connected to the business place 4 through a communication interface, which includes a router and DSU (Digital Service Unit), and a predetermined line 3.

The business place 4 issues a predetermined running instruction toward each tank lorry vehicle 1, and receives various items of information transmitted from the tank lorry vehicle 1. The business place 4 includes a communication interface circuit 41 and a personal computer 42. The communication interface circuit 41 includes a router and DSU (Digital Service Unit), which are connected to the other end of the dedicated line 3. The communication interface circuit 41, which is well known, will not be further explained. The personal computer 42, which includes a computer body 421, display 422, operation unit 423 and storage unit 424, may be known hardware. In this invention, the personal computer 42 is characterized by various items of information and data stored in the storage unit 424 and by the procedure of processing.

The printer 425 connected to the personal computer 42 issues a bill 425a and a report 425b. This will be explained again with reference to FIG. 4 et seq. The personal computer 42 is also connected to a memory card reader/writer 126 which can read the running information of one's own vehicle whose recording on the memory card 14 is legally compelled. The memory card reader/writer 126 corresponds to running information reading means defined in claims and may be a known product.

A position display software program 424a stored in the storage unit 424 displays, on a map drawn using map data 424c, received position information, timing information, etc. in a superposed manner, or otherwise displays the position information, timing information, loadage, delivery information, in a table manner. A report software program 424b serves to create a report 425b. The map data 424c include at least topography, roads and place names in an area correlated with the system according to this invention. The map data 424c also includes correlated data of the position information and place name. A communication module 424d is a communication control software program which enables communication between the communication terminal device 11 mounted in the tank lorry vehicle 1 and the communication terminal device 11′ attached to the tank 61A, 61B. Terminal information 424e is information on the terminal devices 11 and 11′ (or tank lorry vehicle 1 and tank 61A, 61B) which includes at least information correlating the vehicle specifying information and vehicle number of the tank lorry vehicle). Running history information 424f is information used for running management of the tank lorry vehicle which includes correlated information of a vehicle number, running direction, time information, place name, position information, loadage and delivery quantity information for each vehicle. Incidentally, the position display software program 424a, map data 424c, communication module 424d and terminal information 424e are previously installed or recorded. On the other hand, the running history information 424f is sequentially updated on the basis of the information and signals transmitted from the tank lorry vehicle 1. The card information 424g is sequentially updated whenever the contents of the memory card 14 are read. Incidentally, although not shown, the remaining level warning information transmitted from the tank 61A, 61B may also be stored in the storage unit 424.

The tank 61A, 61B installed on the factory of the user 6A, 6B is provided with the communication terminal device 11′ and level sensor 62. The communication terminal device 11′ has the same configuration as that of the communication terminal device 11 mounted on the tank lorry vehicle 1. The communication terminal device 11′ stores tank specifying information in place of the above vehicle specifying information. The level sensor 62 may be a known device which is attached to the tank 61A, 61B and produces the level detecting signal corresponding to the liquid surface level of the liquefied gas. This level detecting signal is supplied to the communication terminal device 11′ and used to decide whether or not the remaining level of the liquefied gas in the tank 61A, 61B has fallen short of a warning level. If the remaining level of the liquefied gas has fallen short of the warning level, the remaining level warning information as well as the tank specifying information, position information and time information is transmitted to the business place 4 via the portable telephone packet communication network 2 and dedicated line 3. In order to measure the remaining level of the liquefied gas in the tank 61A, 61B, a load sensor 63 may be used in place of the level sensor 62. The measurement itself of the remaining level using the load sensor 63, which is known from JP-A-2002-5731, will not further described in detail.

The operation of the above configuration will be explained briefly. The loadage of the liquefied gas carried on the tank lorry vehicle 1 is measured on the basis of the load detected by the load sensor attached to a predetermined position of the tank lorry vehicle 1. The loadage as well as the position information, time information and vehicle specifying information of one's own vehicle based on the GPS signal is transmitted from the tank lorry vehicle 1 to the business place 4. The business place 4 receives the position information, time information, vehicle specifying information and loadage which are to be outputted from the display 422. Therefore, the side of the business place can exactly know the behavior of the tank lorry including the loadage and position information in the tank lorry vehicle, thereby permitting the effective running management for the tank lorry vehicle and reduction in physical distribution cost. The conventional measurement at the platform is not also necessary so that the cost for measurement and physical distribution can be reduced. Further, the reciprocating transportation to/from the predetermined platform is not also necessary so that the gas loss due to the transportation can be reduced.

The delivery quantity of the liquefied gas based on the load value may be computed on the side of the tank lorry vehicle 1, and transmitted to the business place so that it is displayed. Further, on the basis of the delivery quantity, the invoice 15a can be issued on the spot by the printer 15 incorporated in the tank lorry vehicle 1. This permits a face-to-face transaction which leads to performing the business effectively. Further, on the basis of the various items of information transmitted from the tank lorry vehicle 1, the bill 425a and report 425b can be issued by the printer 425 installed on the business place 4, thereby improving business efficiency.

Further, the remaining level warning information of the liquefied gas in the tank 61A, 61B of the user 6A, 6B as well as the tank position information, warning time information and tank specifying information is transmitted to the business place 4 through the portable telephone packet communication network 2 and dedicated line 3. The business place 4 receives these items of information to be outputted from the display unit 422. Therefore, the side of the business place 4 can manage the running of the tank lorry vehicle 1 also in view of the real-time demand on the side of the user 6A, 6B.

The tank lorry vehicle 1 collects the running information of one's own vehicle whose recording is legally compelled, the running information thus collected is recorded on the memory card 14 in correlation with the loadage. The business place 4 reads the running information and loadage from the memory card 14 to issue the report 425b on which the running information and loadage are correlated with each other. Therefore, as required, the exact running information inclusive of the speed, time, distance, etc. and loadage correlated therewith can be provided to the users.

A modification of the system according to this invention shown in FIG. 2 may use ASP (Application Service Provider) The ASP is a business or enterprise who provides various kinds of service using a wide area communication network such as an internet which is prevailing in recent years. In this case, ASP is also communicated with the portable telephone packet communication network 2 and with the internet via a predetermined connecting sensor, and stores the above various kinds of information from the tank lorry vehicle 1 and tank 61A, 61B on a server. As the occasion demands, the business place 4 having the tank lorry vehicle can receive various kinds of information from the server of the ASP using the internet. Therefore, this system can be easily structured and also provide a very effective carrier vehicle running management supporting system with low running cost.

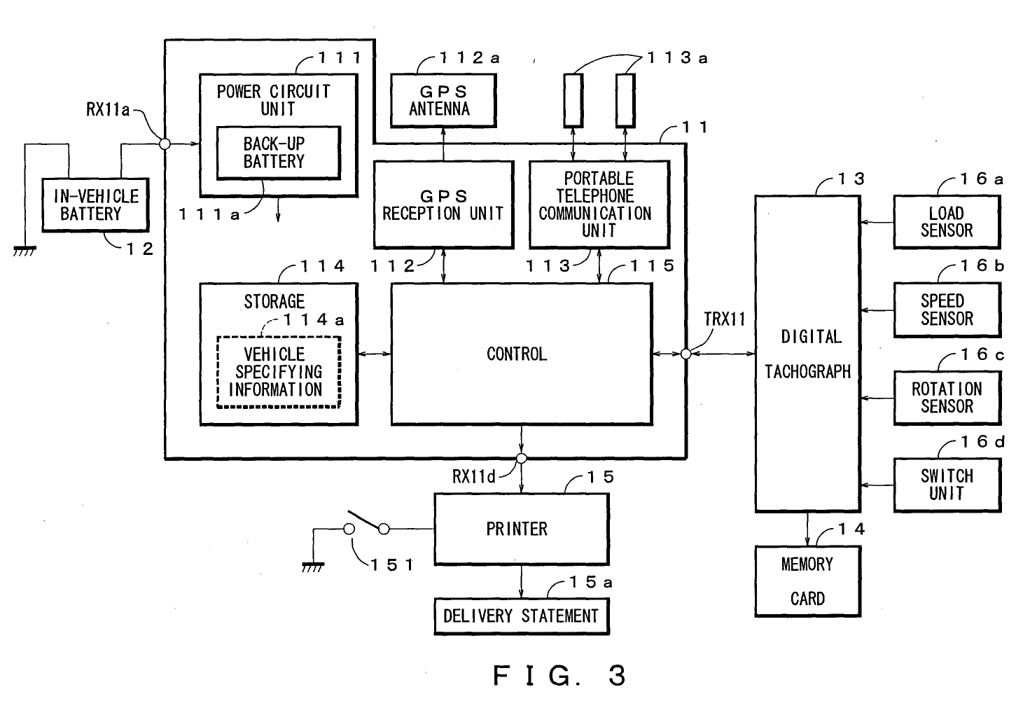

An explanation will be given of the communication terminal device according to this invention and various devices connected thereto. FIG. 3 is a block diagram showing an arrangement of the communication terminal device and its connection to correlated devices. The communication terminal device 11 installed on the tank lorry vehicle 1 and the communication terminal device 11 attached to the tank 61A, 61B have the same configuration. Therefore, the explanation will be basically given with reference to the communication terminal device 11 mounted on the tank lorry vehicle 1.

The tank lorry vehicle 1, as shown in FIG. 3, incorporates a communication terminal device 11, a known 12V type in-vehicle battery 12, a digital tachograph 13, printer 15, etc. Between the communication terminal device 11 and the in-vehicle battery 13, an engine key switch (not shown) is located which includes an off-position OFF, accessory position ACC, on-position ON, engine start position ST, etc. The battery output from the in-vehicle battery 12 is also supplied to various sensors and printer 15 as required. The in-vehicle battery 12 may be any other battery than the 12-V type battery.

The communication terminal device 11 includes a power circuit unit 111, a portable telephone communication unit 113, storage unit 114 and control unit 115 connected to these units.

The power circuit unit 111 is basically constructed of a DC transforming circuit. The battery voltage 12 V which is supplied from the in-vehicle battery 12 and applied to a power source input terminal RX11a is transformed into a voltage (e.g. 5 V) which is suited to the respective electronic units of this communication terminal device 11, and distributed. Incidentally, the power circuit unit 111 also includes a back-up battery 111a which serves as an auxiliary power source of the in-vehicle battery 12. The power circuit unit 111 may be provided as a separate body from the communication terminal device 11.

The GPS receiving unit 112 receives GPS signals from a plurality of GPS satellites 7 constituting the GPS through a GPS antenna, acquires the present position information on the basis of the GPS signals, and supplies the information to the control unit 115. The portable telephone communication unit 113 are wireless-connected to the wireless station 21 of the portable telephone packet communication network 2 through packet communication antennas 113a. These GPS receiving unit 112 and the portable telephone communicating unit 113 may be previously known units. Incidentally, the GPS receiving unit 113 corresponds to the position information acquiring means and tank position information acquiring means defined in claims and the portable telephone communication unit 113 corresponds to the transmitting means defined in claims.

The storage unit 114 stores at least vehicle specifying information 114a for specifying the tank lorry vehicle 1. As for the communication terminal device 11′, the storage unit 114 stores the tank specifying information in place of the vehicle specifying information 114a. The vehicle specifying information 114a and tank specifying information are IDs for specifying the tank lorry vehicle 1 and tank 61A, 61B, but those for specifying the communication terminal device 11, 11′ itself. In short, the specifying information has only to specify each tank lorry vehicle 1 and each tank 61A, 61B. Incidentally, the storage unit 114 corresponds to the vehicle specifying information storage means and the tank specifying information storage means.

The control unit 115 maybe a microcomputer which includes CPU, ROM and RAM. CPU executes the various kinds of processing according to this embodiment along the control program stored in the ROM. RAM stores data, programs, etc. required for the CPU to execute the various kinds of processing as required. According to the above control program, the control unit 115 reads the vehicle specifying information 114a stored in the storage unit 114, acquires the position information using the GPS receiving unit 112, and delivery quantity or loadage. These kinds of processing will be described again with reference to FIG. 4 et seq. Apart of each processing executed by the control unit 115 may be also executed by a microcomputer included in a power source adapter externally attached.

The digital tachograph 13 and memory card 14 may be known products available from the company to which the inventors of this invention belong. The digital tachograph 13 is connected to a load sensor 16a, speed sensor 16b, rotation sensor 16c and switch unit 16d. As previously described, the load sensor 16a is mounted on the frame or axle of the tank lorry vehicle 1 to detect the load of the tank lorry vehicle 1. The speed sensor 16b and rotation sensor 16c serve to detect the running speed and engine speed of the tank lorry vehicle 1. The switch unit 16d is provided with buttons for inputting a resetting command before load measurement and a command for load measurement. The signals from these sensors and unit are outputted onto the digital tachograph 13 and converted into the corresponding digital information. The information is recorded on the memory card 14 by the reader included in the digital tachograph 13, or supplied to the in-vehicle terminal device 11 through the signal input/output terminal TRX11.

The printer 15 may be a previously known compact printer which is being used in e.g. a taxi. The printer 15 is connected to the communication terminal 11 through the input/output terminal RX11d. In response to the turn-on of a printing switch 151, a delivery sheet 15a on which the delivery quantity calculated by the control unit 115 and others are printed is issued.

Incidentally, the communication terminal device 11′ is directly connected to the level sensor 62 and load sensor 63.

By using the communication terminal device 11, the business place 4 can perform the effective running management of the carrier vehicle such as a tank lorry vehicle using the position information, time information, vehicle specifying information, loadage. Further, the measurement at the platform is not necessary so that the cost for measurement and physical distribution can be greatly reduced. The gas loss due to transportation in the measurement at the platform can be also reduced. The communication terminal device 11′ permits the business place 4 to give the timely supply of the liquefied gas in view of the real-time demand of the user 6A, 6B.

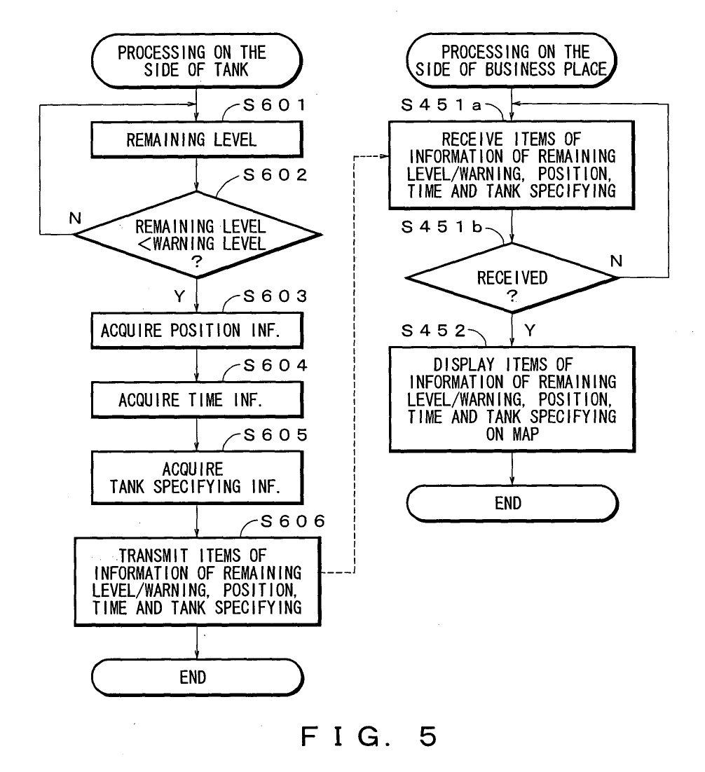

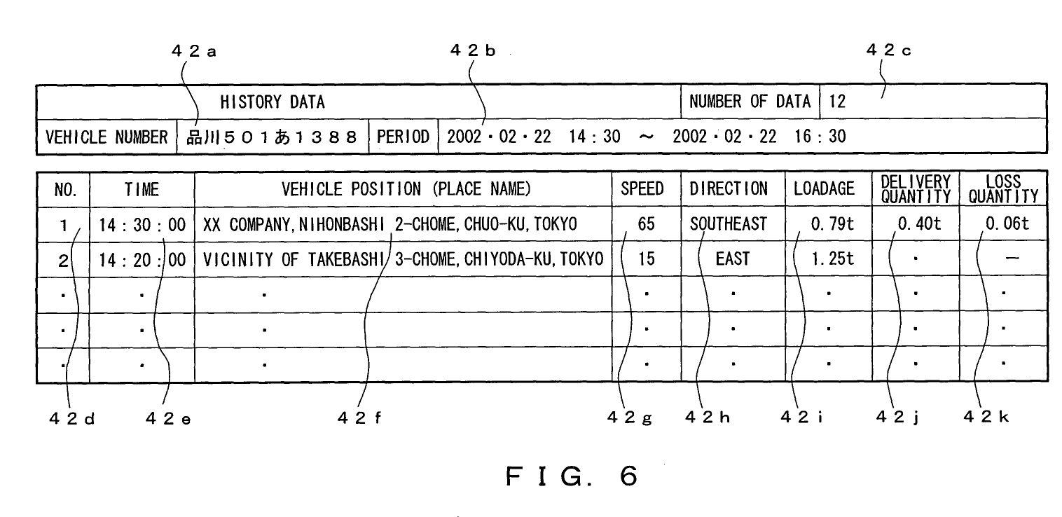

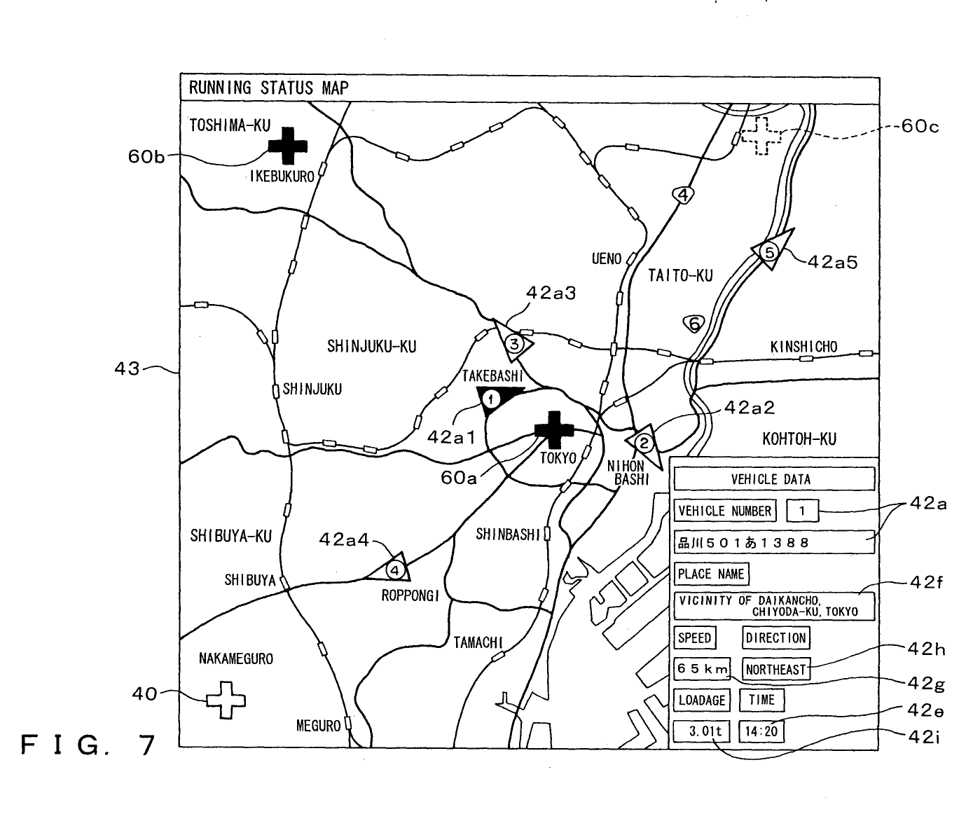

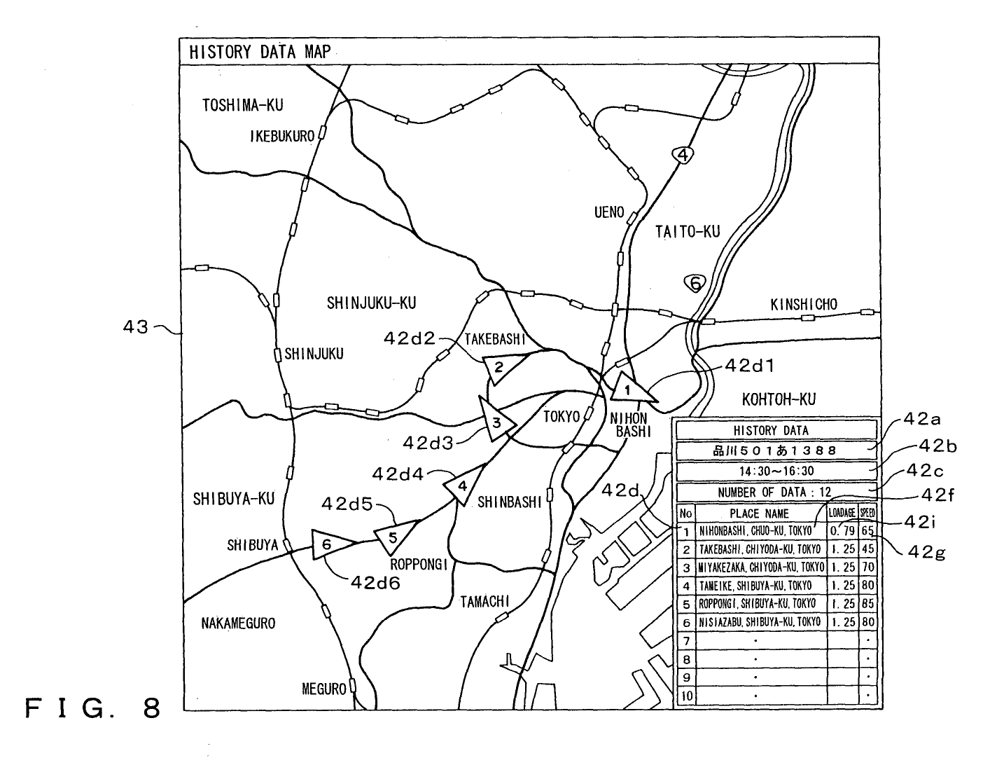

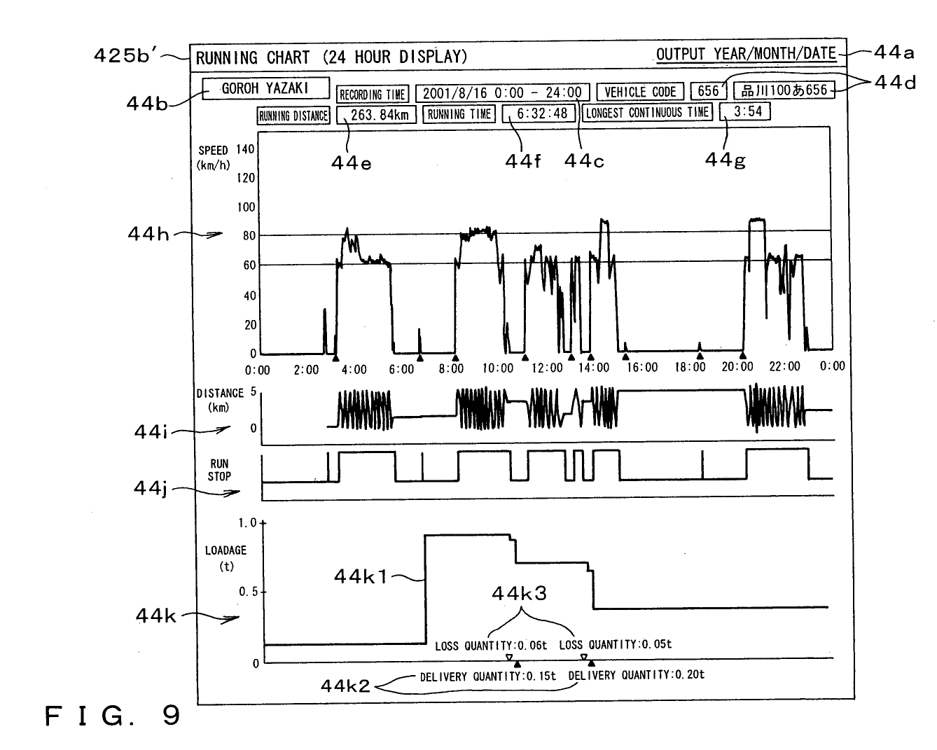

Now referring to FIGS. 4 to 8, an explanation will be given of the processing procedure, communication sequence and examples of history data and running status. FIG. 4 is a flowchart of the processing procedure at the tank lorry vehicle and the business place and the communication sequence therebetween according to an embodiment of this invention. FIG. 5 is a flowchart of the processing procedure at the tank and business place and the communication sequence therebetween according to an embodiment of this invention. FIG. 6 is a view of an example of history data according to an embodiment of this invention. FIG. 7 is a view showing the map of the running status of a carrier vehicle. FIG. 8 is a view showing the map of the history data. FIG. 9 is an exemplary report issued on the basis of card information. Incidentally, actually, although a plurality of tank lorry vehicles communicate with a certain business place, the communication sequence applies to each tank lorry vehicle. Therefore, in FIG. 4, only the processing procedure of a single tank lorry vehicle is shown.

First, with reference to FIGS. 4 and 6 to 9, an explanation will be given of the processing procedure at the tank lorry vehicle and the business place and the communication sequence therebetween. In step S101 of the processing on the side of the tank lorry vehicle, in the communication terminal device 11, the position information is acquired. Specifically, the GPS receiving unit 112 is actuated to start the receiving operation. On the basis of the GPS signal thus received, the present position information is acquired using a previously known method. In addition, in step S102, the time information included in the GPS signal is also acquired (It should be noted that the time information may be acquired without using the GPS signal but using the timer function of the communication terminal device 11). In step S103, the vehicle specifying information 114a is acquired. Namely, the vehicle specifying information 114a is read out from the storage 114.

In step S104, if or not there is a reset command is determined by a predetermined operation of the switch unit 16d. If it is determined that there is the reset command (Y in step S104), the processing proceeds to step S105 in which the measurement of the loadage before delivery and saving operation are performed. Specifically, in step S105, the loadage of the liquefied gas at this time is measured on the basis of the load detected by the load sensor 16a. This loadage is once saved in the RAM as the loadage before delivery. Incidentally, thereafter, the liquefied gas is discharged from the in-vehicle tank of the tank lorry vehicle 1 into the tank 61A of the user 6A.

After the discharging operation has been completed, in step S106, it is determined if or not there is a measurement command by a predetermined operation of the switch unit 16d. If there is the measurement command (Y in step S106), the processing proceeds to step S107 in which in which the measurement of the loadage after delivery and saving operation are performed. Specifically, in step S107, the loadage of the liquefied gas at this time is measured on the basis of the load detected by the load sensor 16a. This loadage is once saved in the RAM as the loadage after delivery.

In step S108, the computing of the delivery quantity and the saving operation are performed. Specifically, on the basis of the difference between the loadage before delivery and the loadage after delivery, the delivery quantity of the liquefied gas is computed. The delivery quantity is once saved in the RAM. Incidentally, the delivery quantity can also be computed on the basis of the load before delivery and the load after delivery.

On the other hand, in step S109, the above loadage before delivery and the above loadage after delivery are recorded on the memory card 14. In this case, since the information such as the time, speed detected by the speed sensor, distance measured on the basis of the speed, etc. whose recording is legally compelled and the engine speed detected by the rotation sensor 16c are recorded on the memory card 14, in the digital tachograph 13, the loadage before delivery and the loadage after delivery correlated therewith are recorded.

In step S110, it is determined if or not there is a command of issuing a statement of delivery. This command is given in response to the turn-on of the printing switch 151 of the printer 15. If there is the command (Y in step S110), the processing proceeds to step S111 in which the delivery quantity is read from the RAM. In step S112, the statement of delivery 15a in a predetermined format is created. In step S113, the statement of delivery 15a is issued. On the statement of delivery 15a, e.g. date, delivery quantity, delivery destination, deliverer, etc. are printed. Steps S111, S112 and S113 and hardware correlated with these steps correspond to the delivery statement issuing means defined in claims.

In step S114, position information, time information, vehicle specifying information, delivery quantity and loadage are transferred to the business place 4 through the portable telephone communicating unit 113, portable telephone packet communicating network 2, dedicated line 3, etc.

If it is determined “N” in steps S104, step S106 and S110, the processing related with the above measurement and issuance of the delivery statement is not executed, but proceeds to step S114. In this case, the updated information of delivery quantity and loadage saved in the RAM is transferred. The processing from step S101 to S114 is periodically executed at regular intervals from when a prescribed starting trigger is detected to when a prescribed ending trigger is detected. Specifically, regardless of the presence or absence of the above measurement command, the position information and time information are periodically transferred as well as the vehicle specifying information and the updated delivery quantity information and loadage. This interval can be previously set, e.g. 1 minute to 60 minutes. It is of course that only when there is the measurement command, the position information, time information, vehicle specifying information, delivery quantity information and loadage may be transferred.

On the other hand, in FIG. 4, in steps S401 and S401b the side of the business place waits for reception of the position information, time information, vehicle specifying information and delivery quantity information and loadage from the side of the tank lorry vehicle 1 (N in step S401b). If these items of information is received, the processing proceeds to step S402 (Y in step S401b). Each item of information from the tank lorry vehicle 1 is transferred through the portable telephone packet communication network 2 and dedicated line 3, and converted, by the interface circuit 41, into the signal format which can be processed by the personal computer 42. Step S401a and step S401b and the hardware correlated therewith correspond to the receiving means defined in claims.

In step S402, the received position information, time information, vehicle specifying information, delivery quantity information and loadage are saved as running history information 424f in the storage unit 424. The running history information 424f, as shown in FIG. 6, includes the vehicle specifying information 42a, time information 42b, 42e, position information 42f, loadage 42i and delivery quantity information 42j which are correlated for each vehicle. The running history information 424f may also include the number of data 42c, speed information 42g, timing information 42d, advancing direction information 42h, loss quantity information 42k, etc. Incidentally, the speed information 42g and advancing direction information 42h can be computed on the basis of the time information 42e and position information 42f. The loss quantity information 42k can be computed on the basis of the loadage 42i and delivery quantity information 42j. These items of information are saved in the storage unit 424 so that they can be read out as required.

In this embodiment, the loadage 42i and delivery quantity information 42j which have been computed on the side of the tank lorry vehicle 1 are received by the business place 4. In place of this, on the basis of the entire load information measured on the side of the tank lorry vehicle 1 and transferred therefrom, the loadage 42i and delivery quantity information 42j may be computed on the side of the business place 4.

In step S403, the contents of the position information, time information, vehicle specifying information and loadage are displayed on the display 422. As shown in FIG. 7, they can be displayed to indicate the updated running status of the tank lorry vehicle. As seen from FIG. 7, the vehicle specifying information 42a, time information 42e, position information 42f and loadage 42i as well as the map 43 in the relative district drawn on the map data 424c are displayed in a table format. The speed information 42g and advancing direction information 42h may be also displayed in the table format. In this embodiment, only the information relative to the vehicle No. 1 is displayed, but the information relative to the vehicles No. 2 to No. 5 can be selectively displayed by a predetermined operation. On the map 43, each tank lorry vehicle is displayed at the position corresponding to the isosceles triangular character 42a1-42a5 which encircles the vehicle number of each tank lorry and indicates the advancing direction of the vehicle at its apex. On the map 43, the business place 40, destination A 60a, destination B 60b may be displayed. On the map 43, the business place 40, destination A 60a and destination B 60b corresponds to e.g. the positions of the business place 4 and users 6A, 6B.

The above items of information can also be displayed as history data of a specific tank lorry vehicle as seen from FIG. 8. In FIG. 8, as regards timing points No. 1 to No. 6, the vehicle specifying information 42a, time information 42b, position information 42f and loadage 42i as well the map of the relative district drawn on the basis of the map data 424c are displayed in a time sequence in a table format. In addition, the number of data 42c, speed information 42g, timing point information 42d, etc. may also be displayed in the table format. On the map 43, at the corresponding positions, isosceles triangular characters 42d1-42d6 may be displayed which encircles the number corresponding to the timing point information 42d of the specific vehicle and indicates the advancing direction of the vehicle at its apex. The specific vehicle whose history data is displayed can be changed by a predetermined operation.

The above items of information may be displayed in the other formats than FIGS. 7 and 8. For example, only the necessary items of information may be displayed in the table format with no map. Although not shown, the delivery quantity information 42j and the loss quantity information 42k may be displayed. By displaying the delivery quantity 42j, the business place can know instantaneously whether or not a scheduled delivery operation has been timely performed. By displaying the loss quantity information 42k, the business place can exactly perform cost management. Step S403 and the hardware related thereto correspond to the outputting means defined in claims.

On the other hand, in step S404, the information recorded on the memory card 14 such as the speed, time, distance, etc. whose recording is legally compelled, engine speed detected by the rotation sensor 16c, and loadages before delivery and after delivery correlated therewith is read by a memory card reader/writer 426. In step S405, these items of information are saved in the storage unit 424.

In step S406, if it is determined that there is a report issuing command by the operation of the operation unit 423 (Y in step S406), the processing proceeds to step S407. In step S407, necessary items of information of the running history information 424f and card information 424g are read from the storage unit 424. In step S408, a report 425b in a predetermined format is created, and in step S409, the report 425b is printed out by the printer 425. The report 425b is roughly classified into that based on the running history information 424f and that based on the card information 424g. Therefore, the type of the report is specified by the report issuing command.

The report based on the running history information is e.g. a sheet on which the information as shown in FIG. 6 is printed in the table format. The report based on the card information 424g is e.g. a sheet as shown in FIG. 9. Specifically, this report can be issued as a running chart (during 24 hours) 425b′. The running chart 425′ includes a output year-month-date 44a, driver name 44b, recording time 44c, vehicle code/number 44d, running distance 44e, running time 44f, longest continuous running time 44g, speed chart 44h, distance chart 44i, running/stopping chart 44j and loadage chart 44k. The other charts than the loadage chart may be created in previously known formats.

The loadage chart 44k is correlated with the speed chart 44h, distance chart 44i and running/stopping chart 44j in terms of e.g. time. The loadage chart 44k includes e.g. time chart 44k1 representative of the loadage and delivery quantity 44k2 and loss quantity 44k3 which are computed on the loadage at each timing point. Therefore, as required, the user can receive the exact running information inclusive of the speed, time, distance acquired by each sensor and loadage related thereto.

Incidentally, steps S407, S408 and S408 and the hardware related thereto correspond to the report issuing means defined in claims.

In step S410, if it is determined that there is a bill issuing command by the operation of the operation unit 423 (Y in step S410), the processing proceeds to step S411. In step S411, necessary items of information of the running history information 424f are read from the storage unit 424. In step S412, a bill 425a in a predetermined format is created, and in step S413, the bill 425a is printed out by the printer 425. On the bill 425a, e.g. date, delivery quantity, delivery destination, deliverer, billed amount, etc. are printed. Steps S411, S412 and S413 and hardware related thereto correspond to the bill issuing means defined in claims.

In steps S406 and S410, if the answer is “N”, the processing on the issuing the report and bill is not carried out, but the processing sequence is ended. The processing on steps S401a to step S413 is repeated until a predetermined ending trigger is detected.

Now referring to FIGS. 5 and 7, an explanation will be given of the processing procedure at the tank and business place and the communication sequence therebetween according to an embodiment of this invention. In step S601 of the processing on the side of the tank in FIG. 5, the remaining level of the tank 61A (61B) of the user 6A (6B) is detected by the level sensor 62. Specifically, the level detected signal corresponding to the liquid surface level of the liquefied gas stored in the tank 61A (61B) is produced. Step S601 and hardware related thereto correspond to the remaining level measuring means defined in claims.

In step S602, it is determined if or not the remaining level becomes less than a prescribed warning level. The warning level is a liquid surface level at which the liquefied gas is to be supplied before hindrance occurs in performing the business on the side of the user 6A (6B). As long as the remaining level does not become less than the warning level, steps S601 and S602 are repeated (N in step S602). If it is determined that the remaining level has become less than the warning level, the processing creates remaining level waning information to proceed to step S603 (Y in step S602). Step 602 corresponds to the remaining level warning information creating means defined in claims.

In steps S603, S604, S605 and 606, the processing corresponding to steps S101, S102, S103 and S114 in FIG. 4 is performed, and so will not be further explained here. However, it should be noted that the remaining level warning information but not the delivery quantity information and loadage is transmitted to the business place 4 through the portable telephone packet communication network 2 and dedicated line 3. It is of course that the position information, time information and specifying information are directed to the tank but not to the vehicle. Steps S603, S604, S605 and S606 and the hardware related thereto correspond to the tank position information acquiring means, warning time information acquiring means, tank specifying information acquiring means and tank side transmitting means in claims.

The processing in steps S601 to S606 is continuously performed until a prescribed ending trigger is detected. If the remaining level become lower than the warning level, the remaining level warning information as well as the position information, time information and specifying information is transmitted. The remaining level for each tank may be measured and transmitted periodically.

On the other hand, in FIG. 5, in steps S451a and S451b the side of the business place waits for reception of the level warning information, position information, time information, and tank specifying information from the side of the tank lorry vehicle 1 (N in step S451b). It these items of information is received, the processing proceeds to step S452 (Y in step S451b). Each item of information from the tank side is transferred through the portable telephone packet communication network 2 and dedicated line 3, and converted, by the interface circuit 41, into the signal format which can be processed by the personal computer 42. Step S451a and step S451b and the hardware correlated therewith correspond to the receiving means defined in claims.

In step S453, the contents of the level warning information, position information, time information and tank specifying information are displayed on the display 422. In this case, as shown in FIG. 7, the location of the user corresponding to the tank which has transmitted the level warning information is blink-displayed as destination C60c. The blinking color may be a conspicuous color. Although not shown, the time information may be indicated together. Step S451 and the hardware related thereto correspond to the outputting means defined in claims. The processing from step S451a to S452 is repeated until a prescribed trigger is detected. By the processing procedure as shown in FIG. 5, the business place 4 can give the timely supply of the liquefied gas in view of the real-time demand of the user.

In accordance with this embodiment, the business place can exactly know the behavior inclusive of loadage and position information of the carrier vehicle such as a tank lorry vehicle, thereby performing effective running management and reducing the cost for physical distribution for the carrier vehicle such as a tank lorry vehicle. Where the carrier vehicle is a tank lorry vehicle, since a conventional platform measurement is necessary, the measurement cost and distribution cost can be greatly reduced. In addition, the reciprocating transportation to the predetermined platform is not necessary so that the gas loss due to transportation can be reduced.

In accordance with this embodiment, on the side of the carrier vehicle such as a tank lorry vehicle, a delivery statement can be automatically issued whereas on the side of the business place, a bill or a predetermined report can be automatically issued, thereby greatly improving the business efficiency. Further, in accordance with this embodiment, the business place 4 can give the timely supply of the liquefied gas in view of the real-time demand of the user.

Further, on the side of the tank lorry vehicle, the running information of one's own vehicle whose recording is legally compelled is collected and recorded in correlation with the loadage on the memory card, whereas on the side of the business place, the running information and loadage are read from the memory card 14 and the report 425 correlated with the running information and the loadage is issued. Thus, as required, the user can be given the more exact running information inclusive of the speed, time, distance, etc.

Incidentally, this invention should not be limited to the above embodiment, but can be realized in various modifications without departing from the scope of this invention. For example, the formats of the outputs and the delivery statement and bill can be modified as required. It is needless to say that this invention can be applied to not only the fuel transportation by the tank lorry vehicle but also to the carrier vehicle for industrial waste.

What is claimed is:

1. A system for assisting running management of a plurality of carrier vehicles which carry predetermined material goods to a predetermined destination,
position information acquiring means mounted on said carrier vehicle, for acquiring one's own vehicle position information on the basis of a GPS signal;
time information acquiring means mounted on said carrier vehicle, for acquiring time information corresponding to said position information;
vehicle specifying information storing means mounted on said carrier vehicle, for storing vehicle specifying information used to specify one's own vehicle;
vehicle specifying information acquiring means mounted on said carrier vehicle, for acquiring the vehicle specifying information from said vehicle specifying storing means;
loadage measuring means for measuring loadage of the material goods loaded on the carrier vehicle on the basis of load detected by a load sensor attached to a predetermined position of said carrier vehicle;
transmitting means mounted on said carrier vehicle, for transmitting said position information, time information, vehicle specifying information and loadage to a business place through a communication network inclusive of a wireless line;
receiving means installed on said business place to which the carrier vehicle belongs, for receiving said position information, time information, vehicle specifying information and loadage through said communication network; and
outputting means installed on said business place, for outputting said position information, time information, vehicle specifying information and loadage.

2. A system according to claim 1, wherein said carrier vehicle is a tank lorry vehicle for carrying liquefied gas produced at a liquefied gas producing base to a predetermined user.

3. A system according to claim 2, further comprising
delivery quantity computing means mounted on said tank lorry vehicle, for computing a delivery quantity of said liquefied gas to said user on the basis of said load, wherein said transmitting means and said receiving means transmits and receives said delivery quantity, respectively, and said outputting means outputs said delivery quantity.

4. A system according to claim 3, wherein said outputting means further outputs a loss quantity of said liquefied gas lost during carrying of the liquefied gas by said tank lorry vehicle.

5. A system according to any one of claims 2 to 4, further comprising:
delivery statement issuing means mounted on said tank lorry vehicle, for issuing a delivery statement for a user supplied with said liquefied gas on the basis of said delivery quantity.

6. A system according to claim 3, further comprising:
running history information saving means installed on said business place, for saving, as running history information, said position information, time information, vehicle specifying information, loadage and delivery quantity, and
bill issuing means installed on said business place, for creating/issuing a bill for said user supplied with the liquefied gas on the basis of said running history information.

7. A system according to claim 3, further comprising:
running history information saving means installed on said business place, for saving, as running history information, said position information, time information, vehicle specifying information, loadage and delivery quantity, and
report issuing means installed on said business place, for creating/issuing a bill for said user supplied with the liquefied gas on the basis of said running history information.

8. A system according to claim 6, wherein
said outputting means outputs said running history information superposed on a map image of a related district.

9. A system according to claim 2, further comprising:
remaining level measuring means attached to a tank installed on the user's side, for measuring the remaining level of the liquefied gas in the tank;
remaining level warning information creating means attached to said tank, for creating remaining level warning information indicative of that said remaining level has become lower than a prescribed waning level;
tank position information acquiring means attached to said tank, for acquiring tank position information of one's own tank on the basis of the GPS signal;
warning time information acquiring means attached to said tank, for acquiring warning time information which is a time when said remaining level warning information is created;
tank specifying information storing means attached to said tank, for specifying tank specifying information used to specify one's own tank;
tank specifying information acquiring means attached to said tank, for acquiring the tank specifying information from said tank specifying information storing means; and
tank-side transmitting means attached to said tank, for transmitting said tank position information, warning time information, tank specifying information and remaining level warning information, wherein
said receiving means further receives said tank position information, warning time information, tank specifying information and remaining level information through said communication network, and
said outputting means further receives items of said tank position information, warning time information, tank specifying information and remaining level information through said communication network.

10. A system according to claim 9, wherein
said items of information transmitted from said transmitting means and said tank-side transmitting means are saved in a server of an application service provider communicated with said transmitting means and said tank-side transmitting means through a portable telephone packet communication network in a data quantity accounting system as said wireless communication network; and
said receiving means installed on said business place receives said items of information saved in said server using an internet.

11. A communication terminal device installed on a carrier vehicle for providing a predetermined item of information on running of said carrier vehicle to a business place to which a plurality of carrier vehicles for carrying a predetermined material good to a predetermined destination belong, comprising:
position information acquiring means for acquiring one's own position information on a GPS signal;
time information acquiring means for acquiring time information corresponding to said position information;
vehicle specifying information storing means for storing vehicle specifying information used to specify one's own vehicle;
vehicle specifying information acquiring means for acquiring said vehicle specifying information from said vehicle specifying information storing means;
loadage measuring means for measuring loadage of the material good carried on one's own vehicle on the basis of a load detected by a load sensor attached to a predetermined position of one's own vehicle;
transmitting means mounted on said carrier vehicle, for transmitting said position information, time information, warning time information, vehicle specifying information and loadage to said business place through a predetermined communication network including a wireless line.

12. A communication terminal device attached to a tank installed on a side of a predetermined user for providing predetermined information on said tank to a business place to which a tank lorry vehicle carries and supplies liquefied gas to the user belongs, comprising:
tank position information acquiring means for acquiring tank position information of the user's own tank on the basis of a GPS signal in response to remaining level warning information indicative of shortage of the liquefied gas in said tank;
warning time information acquiring means for acquiring warning time information which is a time when said remaining level warning information;
tank specifying information storing means for storing tank specifying information which specifies the user's own tank;
tank specifying information acquiring means attached to said tank, for acquiring said tank specifying information from said tank specifying information storing means;
tank-side transmitting means for transmitting said tank position information, warning time information, tank specifying information and remaining level warning information to said business place through a predetermined communication network including a wireless line.

13. A system for assisting running management of a plurality of carrier vehicles which carry predetermined material goods to a predetermined destination,
position information acquiring means mounted on said carrier vehicle, for acquiring one's own vehicle on the basis of a GPS signal;
time information acquiring means mounted on said carrier vehicle, for acquiring time information corresponding to said position information;
vehicle specifying information storing means mounted on said carrier vehicle, for storing vehicle specifying information used to specify one's own vehicle;
vehicle specifying information acquiring means mounted on said carrier vehicle, for acquiring the vehicle specifying information from said vehicle specifying storing means;
loadage measuring means for measuring loadage of the material goods loaded on the carrier vehicle on the basis of load detected by a load sensor attached to a predetermined position of said carrier vehicle;
transmitting means mounted on said carrier vehicle, for transmitting said position information, time information, vehicle specifying information and loadage to a business place through a communication network inclusive of a wireless line;
running information collecting/recording means mounted on said carrier vehicle, for collecting running information of one's own vehicle whose recording is at least legally compelled and for recording the running information in correlation with said loadage on a portable recording medium;
receiving means installed on said business place to which the carrier vehicle belongs, for receiving said position information, time information, vehicle specifying information and loadage through said communication network;
outputting means installed on said business place, for outputting said position information, time information, vehicle specifying information and loadage;
running information reading means installed on said business place, for reading said running information and loadage from said portable recording medium; and
report issuing means for creating/issuing a report correlated with said running information and said loadage.

14. A system according to claim 13, wherein
said running information collecting means is a tachograph, and
said portable recording medium is a memory card having a security function.
